(19) United States
(12) Patent Application Publication
(10) Pub. No.: US 2013/0138231 A1
(43) Pub. Date: May 30, 2013

(54) APPARATUS, SYSTEM AND METHOD FOR ACTIVATING FUNCTIONS IN PROCESSING DEVICES USING ENCODED AUDIO

(71) Applicants: William John McKenna, Barrington, IL (US); John Stavropoulos, Edison, NJ (US); Alan Neuhauser, Silver Spring, MD (US); Jason Bolles, Highland, MD (US); John Kelly, COLUMBIA, MD (US); Wendell Lynch, East Lansing, MI (US)

(72) Inventors: William John McKenna, Barrington, IL (US); John Stavropoulos, Edison, NJ (US); Alan Neuhauser, Silver Spring, MD (US); Jason Bolles, Highland, MD (US); John Kelly, COLUMBIA, MD (US); Wendell Lynch, East Lansing, MI (US)

(73) Assignee: ARBITRON, INC., COLUMBIA, MD (US)

(21) Appl. No.: 13/307,649

(22) Filed: Nov. 30, 2011

(51) Int. Cl. G06F 17/00

(52) U.S. Cl. 700/94

(57) ABSTRACT

Apparatus, system and method for accessing supplementary data on a device capable of receiving multimedia are disclosed. After multimedia is received, ancillary code is detected from an audio portion of the multimedia. The ancillary code includes a plurality of code symbols arranged in a plurality of layers in a predetermined time period, wherein data associated with the supplementary data is arranged in at least one of the plurality of layers. Supplementary data is accessed using the data associated with the supplementary data.

### TECHNICAL FIELD

The present disclosure is directed to processor-based audience analytics and device control. More specifically, the disclosure describes systems and methods for utilizing encoded audio in order to activate functions in a processing device, such as a smart phone, tablet and/or a computer. Systems and methods are also disclosed for using the activated functions for retrieving supplementary information based on ancillary codes embedded in an audio signal.

### BACKGROUND INFORMATION

For many years, techniques have been proposed for mixing codes with audio signals so that (1) the codes can be reliably reproduced from the audio signals, while (2) the codes are inaudible when the audio signals are reproduced as sound. The accomplishment of both objectives is essential for practical application. For example, broadcasters and producers of broadcast programs, as well as those who record music for public distribution will not tolerate the inclusion of audible codes in their programs and recordings.

There is considerable interest in encoding audio signals with information to produce encoded audio signals having substantially the same perceptible characteristics as the original unencoded audio signals. Known techniques exploit the psychoacoustic masking effect of the human auditory system whereby certain sounds are humanly imperceptible when received along with other sounds. One such technique utilizing the psychoacoustic masking effect is described in U.S. Pat. No. 5,450,490 and U.S. Pat. No. 5,764,763 (Jensen et al.), both of which are incorporated by reference in their entirety herein, in which information is represented by a multiple-frequency code signal which is incorporated into an audio signal based upon the masking ability of the audio signal. The encoded audio signal is suitable for broadcast transmission and reception as well as for recording and reproduction. When received the audio signal is then processed to detect the presence of the multiple-frequency code signal. Sometimes, only a portion of the multiple-frequency code signal, e.g., a number of single frequency code components, inserted into the original audio signal are detected in the received audio signal. If a sufficient quantity of code components is detected, the information signal itself may be recovered.

While audio encoding technology has improved to allow for greater accuracy in detecting exposure to media data for the purposes of producing research data (e.g., ratings), improvements are needed in the areas of device control, and, more particularly, the presentation of supplementary information pursuant to a research operation.

### SUMMARY

The present disclosure relates to any device capable of producing research data relating to media and/or presenting media to a user including over-the-air, satellite or cable audio and/or video broadcasts, streaming video and/or audio, images, HyperText Markup Language (HTML) content, metadata, text, or any other visual and/or auditory indicia. Exemplary devices include cell phones, smart phones, personal digital assistants (PDAs), personal computers, portable computers, televisions, set-top boxes, media boxes, and the like.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique that is humanly perceptible, without regard to the form or content of such data, and including but not limited to audio, video, audio/video, text, images, animations, databases, broadcasts, displays (including but not limited to video displays, posters and billboards), signs, signals, web pages, print media and streaming media data.

The term “research data” as used herein means data comprising (1) data concerning usage of media data, (2) data concerning exposure to media data, and/or (3) market research data.

The term “presentation data” as used herein means media data or content other than media data to be presented to a user.

The term “ancillary code” as used herein means data encoded in, added to, combined with or embedded in media data to provide information identifying, describing and/or characterizing the media data, and/or other information useful as research data.

The terms “reading” and “read” as used herein mean a process or processes that serve to recover research data that has been added to, encoded in, combined with or embedded in, media data.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, function, activity or thing from another, and are not used to designate relative position, or arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” and “communicating” and as used herein include both conveying data from a source to a destination, and delivering data to a communications medium, system, channel, network, device, wire, cable, fiber, circuit and/or link to be conveyed to a destination and the term “communication” as used herein means data so conveyed or delivered. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware, tangibly-embodied software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage” and “data storage” as used herein mean one or more data storage devices, apparatus, programs, circuits, components, systems, subsystems, locations and storage media serving to retain data, whether on a temporary or permanent basis, and to provide such retained data.

Various apparatus, systems and methods are disclosed for decoding audio data for audience measurement purposes including an integrated system that provides an efficient and compact solution. The integrated system provides flexibility for installing audience measurement capabilities into various processing devices across numerous operating platforms.

### BRIEF DESCRIPTION OF THE DRAWINGS

The present invention is illustrated by way of example and not limitation in the figures of the accompanying drawings, in which like references indicate similar elements and in which:

FIG. 1 is an exemplary embodiment of a system for decoding audio and obtaining supplemental information;

FIG. 2 is an exemplary message structure for decoding messages that may be suitable for obtaining supplemental information;

FIG. 3 illustrates an exemplary decoding process under one embodiment;

FIG. 4 is an exemplary flow chart illustrating a methodology for retrieving an information code from an encoded audio signal;

FIG. 5 is an exemplary flow chart illustrating another methodology for retrieving an information code from an encoded audio signal; and

FIG. 6 illustrates a configuration for processing and retrieving supplementary information under one embodiment.

### DETAILED DESCRIPTION

Various embodiments of the present invention will be described herein below with reference to the accompanying drawings. In the following description, well-known functions or constructions are not described in detail since they would obscure the invention in unnecessary detail.

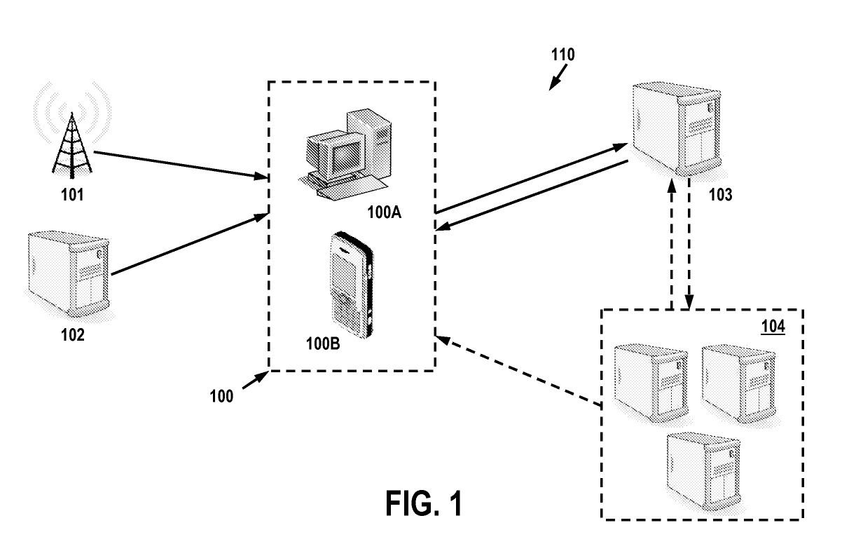

FIG. 1 illustrates an exemplary system 110 where a user device 100 may receive media received from a broadcast source 101 and/or a networked source 102. It is understood that other media formats are contemplated in this disclosure as well, including over-the-air, cable, satellite, network, internetwork (including the Internet), distributed on storage media, or by any other means or technique that is humanly perceptible, without regard to the form or content of such data, and including but not limited to audio, video, audio/video, text, images, animations, databases, broadcasts, and streaming media data. With regard to device 100, the example of FIG. 1 shows that the device 100 can be in the form of a stationary device 100A, such as a personal computer, and/or a portable device 100B, such as a cell phone (or laptop, tablet, etc.). Device 100 is communicatively coupled to server 103 via wired or wireless network. Server 103 may be communicatively coupled via wired or wireless connection to one or more additional servers 104, which may further communicate back to device 100.

As will be explained in further details below, device 100 captures ambient encoded audio through a microphone (not shown), preferably built in to device 100, and/or receives encoded audio through a wired or wireless connection (e.g., 802.11g, 802.11n, Bluetooth, etc.). After the encoded audio is decoded, one or more messages are detected. Each message may then used to trigger an action on device 100. Depending on the content of the message(s), the decoding process may result in the device (1) displaying an image, (2) displaying text, (2) displaying an HTML page, (3) playing video and/or audio, (4) executing a script, or any other similar function. The image may be a pre-stored digital image of any kind (e.g., JPEG) and may also be barcodes, QR Codes, and/or symbols for use with code readers found in kiosks, retail checkouts and security checkpoints in private and public locations. Additionally, the message may trigger device 100 to connect to server 103, which would allow server 103 to provide data and information back to device 100, and/or connect to additional servers 104 in order to request and/or instruct them to provide data and information back to device 100.

In certain embodiments, a link, such as an IP address or Universal Resource Locator (URL), may be used as one of the messages. Under a preferred embodiment, shortened links may be used in order to reduce the size of the message and thus provide more efficient transmission. Using techniques such as URL shortening or redirection, this can be readily accomplished. In URL shortening, every “long” URL is associated with a unique key, which is the part after the top-level domain name. The redirection instruction sent to a browser can contain in its header the HTTP status 301 (permanent redirect) or 302 (temporary redirect). There are several techniques that may be used to implement a URL shortening. Keys can be generated in base 36, assuming 26 letters and 10 numbers. Alternatively, if uppercase and lowercase letters are differentiated, then each character can represent a single digit within a number of base 62. In order to form the key, a hash function can be made, or a random number generated so that key sequence is not predictable. The advantage of URL shortening is that most protocols are capable of being shortened (e.g., HTTP, HTTPS, FTP, FTPS, MMS, POP, etc.).

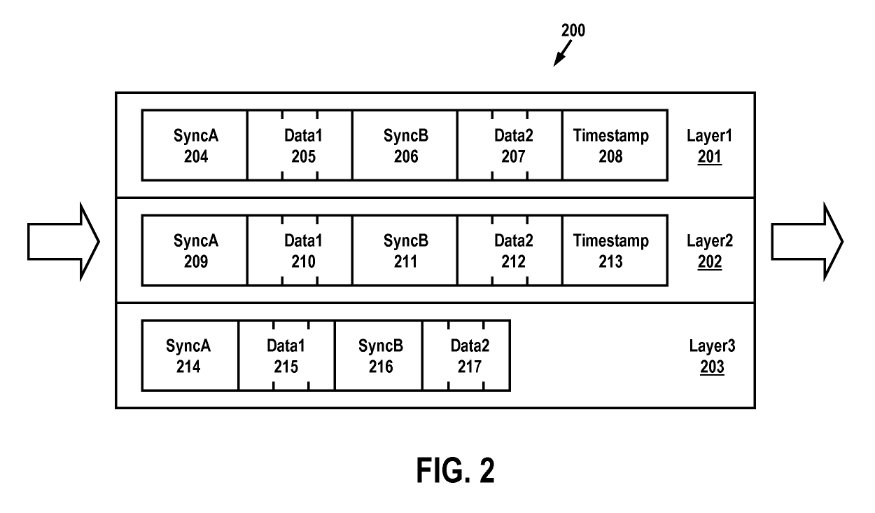

FIG. 2 illustrates a message 200 that may be embedded/encoded into an audio signal. In this embodiment, message 200 includes three layers that are inserted by encoders in a parallel format. Suitable encoding techniques are disclosed in U.S. Patent No. 6,871,180, titled “Decoding of Information in Audio Signals,” issued Mar. 22, 2005, which is assigned to the assignee of the present application, and is incorporated by reference in its entirety herein. Other suitable techniques for encoding data in audio data are disclosed in U.S. Pat. No. 7,640,141 to Ronald S. Kolessar and U.S. Pat. No. 5,764,763 to James M. Jensen, et al., which are also assigned to the assignee of the present application, and which are incorporated by reference in their entirety herein. Other appropriate encoding techniques are disclosed in U.S. Pat. No. 5,579,124 to Aijala, et al., U.S. Pat. Nos. 5,574,962, 5,581,800 and 5,787,334 to Fardeau, et al., and U.S. Pat. No. 5,450,490 to Jensen, et al., each of which is assigned to the assignee of the present application and all of which are incorporated herein by reference in their entirety.

When utilizing a multi-layered message, one, two or three layers may be present in an encoded data stream, and each layer may be used to convey different data. Turning to FIG. 2, message 200 includes a first layer 201 containing a message comprising multiple message symbols. During the encoding process, a predefined set of audio tones (e.g., ten) or single frequency code components are added to the audio signal during a time slot for a respective message symbol. At the end of each message symbol time slot, a new set of code components is added to the audio signal to represent a new message symbol in the next message symbol time slot. At the end of such new time slot another set of code components may be added to the audio signal to represent still another message symbol, and so on during portions of the audio signal that are able to psychoacoustically mask the code components so they are inaudible. Preferably, the symbols of each message layer are selected from a unique symbol set. In layer 201, each symbol set includes two synchronization symbols (also referred to as marker symbols) 204, 206, a larger number of data symbols 205, 207, and time code symbols 208. Time code symbols 208 and data symbols 205, 207 are preferably configured as multiple-symbol groups.

The second layer 202 of message 200 is illustrated having a similar configuration to layer 201, where each symbol set includes two synchronization symbols 209, 211, a larger number of data symbols 210, 212, and time code symbols 213. The third layer 203 includes two synchronization symbols 214, 216, and a larger number of data symbols 215, 217. The data symbols in each symbol set for the layers (201-203) should preferably have a predefined order and be indexed (e.g., 1, 2, 3). The code components of each symbol in any of the symbol sets should preferably have selected frequencies that are different from the code components of every other symbol in the same symbol set. Under one embodiment, none of the code component frequencies used in representing the symbols of a message in one layer (e.g., Layer1 201) is used to represent any symbol of another layer (e.g., Layer2 202). In another embodiment, some of the code component frequencies used in representing symbols of messages in one layer (e.g., Layer3 203) may be used in representing symbols of messages in another layer (e.g., Layer1 201). However, in this embodiment, it is preferable that “shared” layers have differing formats (e.g., Layer3 203, Layer1 201) in order to assist the decoder in separately decoding the data contained therein.

Sequences of data symbols within a given layer are preferably configured so that each sequence is paired with the other and is separated by a predetermined offset. Thus, as an example, if data 205 contains code 1, 2, 3 having an offset of “2”, data 207 in layer 201 would be 3, 4, 5. Since the same information is represented by two different data symbols that are separated in time and have different frequency components (frequency content), the message may be diverse in both time and frequency. Such a configuration is particularly advantageous where interference would otherwise render data symbols undetectable. Under one embodiment, each of the symbols in a layer have a duration (e.g., 0.2-0.8 sec) that matches other layers (e.g., Layer1 201, Layer2 202). In another embodiment, the symbol duration may be different (e.g., Layer 2 202, Layer 3 203). During a decoding process, the decoder detects the layers and reports any predetermined segment that contains a code.

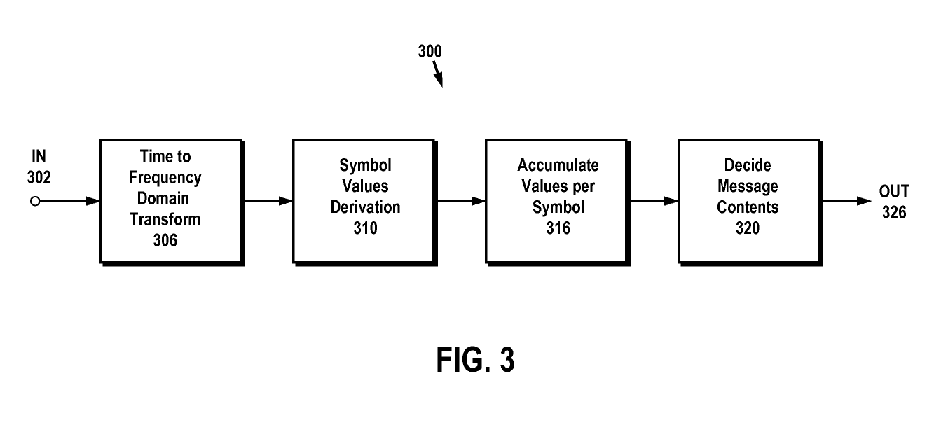

FIG. 3 is a functional block diagram illustrating a decoding apparatus under one embodiment. An audio signal which may be encoded as described hereinabove with a plurality of code symbols, is received at an input 302. The received audio signal may be from streaming media, broadcast, otherwise communicated signal, or a signal reproduced from storage in a device. It may be a direct coupled or an acoustically coupled signal. From the following description in connection with the accompanying drawings, it will be appreciated that decoder 300 is capable of detecting codes in addition to those arranged in the formats disclosed hereinabove.

For received audio signals in the time domain, decoder 300 transforms such signals to the frequency domain by means of function 306. Function 306 preferably is performed by a digital processor implementing a fast Fourier transform (FFT) although a direct cosine transform, a chirp transform or a Winograd transform algorithm (WFTA) may be employed in the alternative. Any other time-to-frequency-domain transformation function providing the necessary resolution may be employed in place of these. It will be appreciated that in certain implementations, function 306 may also be carried out by filters, by a application specific integrated circuit, or any other suitable device or combination of devices. Function 306 may also be implemented by one or more devices which also implement one or more of the remaining functions illustrated in FIG. 3.

The frequency domain-converted audio signals are processed in a symbol values derivation function 310, to produce a stream of symbol values for each code symbol included in the received audio signal. The produced symbol values may represent, for example, signal energy, power, sound pressure level, amplitude, etc., measured instantaneously or over a period of time, on an absolute or relative scale, and may be expressed as a single value or as multiple values. Where the symbols are encoded as groups of single frequency components each having a predetermined frequency, the symbol values preferably represent either single frequency component values or one or more values based on single frequency component values. Function 310 may be carried out by a digital processor, such as a DSP which advantageously carries out some or all of the other functions of decoder 300. However, the function 310 may also be carried out by an application specific integrated circuit, or by any other suitable device or combination of devices, and may be implemented by apparatus apart from the means which implement the remaining functions of the decoder 300.

The stream of symbol values produced by the function 310 are accumulated over time in an appropriate storage device on a symbol-by-symbol basis, as indicated by function 316. In particular, function 316 is advantageous for use in decoding encoded symbols which repeat periodically, by periodically accumulating symbol values for the various possible symbols. For example, if a given symbol is expected to recur every X seconds, the function 316 may serve to store a stream of symbol values for a period of nX seconds (n>1), and add to the stored values of one or more symbol value streams of nX seconds duration, so that peak symbol values accumulate over time, improving the signal-to-noise ratio of the stored values. Function 316 may be carried out by a digital processor, such as a DSP, which advantageously carries out some or all of the other functions of decoder 300. However, the function 310 may also be carried out using a memory device separate from such a processor, or by an application specific integrated circuit, or by any other suitable device or combination of devices, and may be implemented by apparatus apart from the means which implements the remaining functions of the decoder 300.

The accumulated symbol values stored by the function 316 are then examined by the function 320 to detect the presence of an encoded message and output the detected message at an output 326. Function 320 can be carried out by matching the stored accumulated values or a processed version of such values, against stored patterns, whether by correlation or by another pattern matching technique. However, function 320 advantageously is carried out by examining peak accumulated symbol values and their relative timing, to reconstruct their encoded message. This function may be carried out after the first stream of symbol values has been stored by the function 316 and/or after each subsequent stream has been added thereto, so that the message is detected once the signal-to-noise ratios of the stored, accumulated streams of symbol values reveal a valid message pattern.

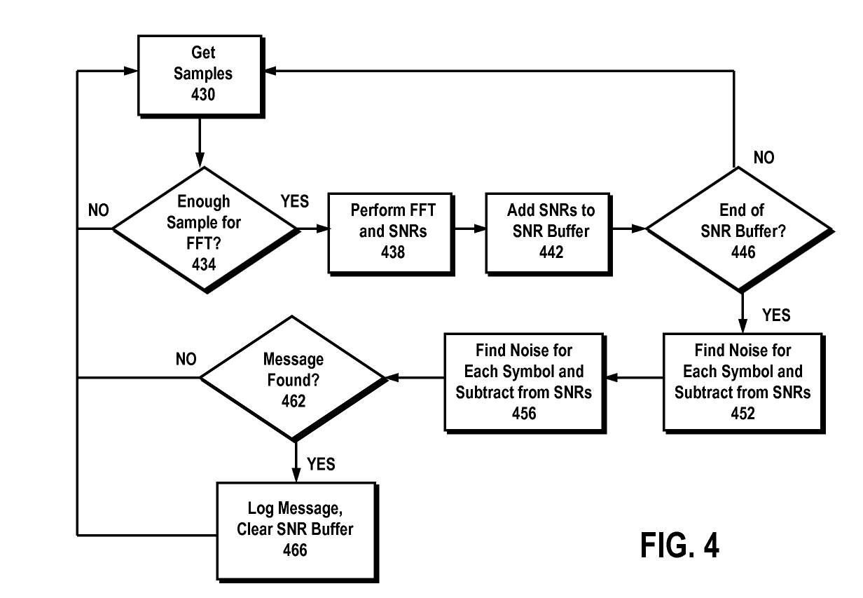

FIG. 4 is a flow chart for a decoder according to one advantageous embodiment of the invention implemented by means of a DSP. Step 430 is provided for those applications in which the encoded audio signal is received in analog form, for example, where it has been picked up by a microphone or an RF receiver. The decoder of FIG. 4 is particularly well adapted for detecting code symbols each of which includes a plurality of predetermined frequency components, e.g. ten components, within a frequency range of 1000 Hz to 3000 Hz. In this embodiment, the decoder is designed specifically to detect a message having a specific sequence wherein each symbol occupies a specified time interval (e.g., 0.5 sec). In this exemplary embodiment, it is assumed that the symbol set consists of twelve symbols, each having ten predetermined frequency components, none of which is shared with any other symbol of the symbol set. It will be appreciated that the FIG. 4 decoder may readily be modified to detect different numbers of code symbols, different numbers of components, different symbol sequences and symbol durations, as well as components arranged in different frequency bands.

In order to separate the various components, the DSP repeatedly carries out FFTs on audio signal samples falling within successive, predetermined intervals. The intervals may overlap, although this is not required. In an exemplary embodiment, ten overlapping FFT's are carried out during each second of decoder operation. Accordingly, the energy of each symbol period falls within five FFT periods. The FFT's are preferably windowed, although this may be omitted in order to simplify the decoder. The samples are stored and, when a sufficient number are thus available, a new FFT is performed, as indicated by steps 434 and 438.

In this embodiment, the frequency component values are produced on a relative basis. That is, each component value is represented as a signal-to-noise ratio (SNR), produced as follows. The energy within each frequency bin of the FFT in which a frequency component of any symbol can fall provides the numerator of each corresponding SNR Its denominator is determined as an average of adjacent bin values. For example, the average of seven of the eight surrounding bin energy values may be used, the largest value of the eight being ignored in order to avoid the influence of a possible large bin energy value which could result, for example, from an audio signal component in the neighborhood of the code frequency component. Also, given that a large energy value could also appear in the code component bin, for example, due to noise or an audio signal component, the SNR is appropriately limited. In this embodiment, if SNR>6.0, then SNR is limited to 6.0, although a different maximum value may be selected.

The ten SNR's of each FFT and corresponding to each symbol which may be present, are combined to form symbol SNR's which are stored in a circular symbol SNR buffer, as indicated in step 442. In certain embodiments, the ten SNR's for a symbol are simply added, although other ways of combining the SNR's may be employed. The symbol SNR's for each of the twelve symbols are stored in the symbol SNR buffer as separate sequences, one symbol SNR for each FFT for 50 μl FFT's. After the values produced in the 50 FFT's have been stored in the symbol SNR buffer, new symbol SNR's are combined with the previously stored values, as described below.

When the symbol SNR buffer is filled, this is detected in a step 446. In certain advantageous embodiments, the stored SNR's are adjusted to reduce the influence of noise in a step 452, although this step may be optional. In this optional step, a noise value is obtained for each symbol (row) in the buffer by obtaining the average of all stored symbol SNR's in the respective row each time the buffer is filled. Then, to compensate for the effects of noise, this average or “noise” value is subtracted from each of the stored symbol SNR values in the corresponding row. In this manner, a “symbol” appearing only briefly, and thus not a valid detection, is averaged out over time.

After the symbol SNR's have been adjusted by subtracting the noise level, the decoder attempts to recover the message by examining the pattern of maximum SNR values in the buffer in a step 456. In certain embodiments, the maximum SNR values for each symbol are located in a process of successively combining groups of five adjacent SNR's, by weighting the values in the sequence in proportion to the sequential weighting (6 10 10 10 6) and then adding the weighted SNR's to produce a comparison SNR centered in the time period of the third SNR in the sequence. This process is carried out progressively throughout the fifty FFT periods of each symbol. For example, a first group of five SNR's for a specific symbol in FFT time periods (e.g., 1-5) are weighted and added to produce a comparison SNR for a specific FFT period (e.g., 3). Then a further comparison SNR is produced using the SNR's from successive FFT periods (e.g., 2-6), and so on until comparison values have been obtained centered on all FFT periods. However, other means may be employed for recovering the message. For example, either more or less than five SNR's may be combined, they may be combined without weighing, or they may be combined in a non-linear fashion.

After the comparison SNR values have been obtained, the decoder examines the comparison SNR values for a message pattern. Under a preferred embodiment, the synchronization (“marker”) code symbols are located first. Once this information is obtained, the decoder attempts to detect the peaks of the data symbols. The use of a predetermined offset between each data symbol in the first segment and the corresponding data symbol in the second segment provides a check on the validity of the detected message. That is, if both markers are detected and the same offset is observed between each data symbol in the first segment and its corresponding data symbol in the second segment, it is highly likely that a valid message has been received. If this is the case, the message is logged, and the SNR buffer is cleared 466. It is understood by those skilled in the art that decoder operation may be modified depending on the structure of the message, its timing, its signal path, the mode of its detection, etc., without departing from the scope of the present invention. For example, in place of storing SNR's, FFT results may be stored directly for detecting a message.

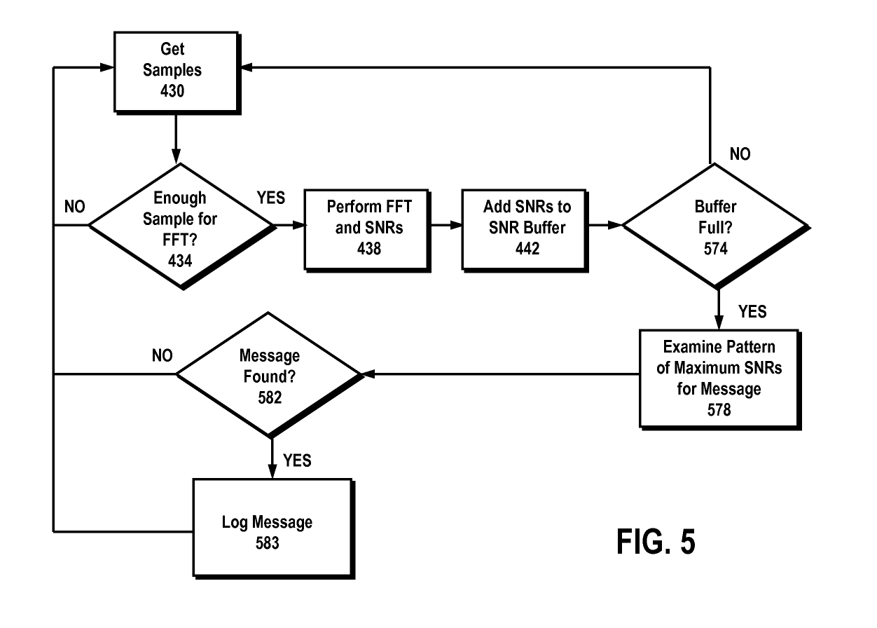

FIG. 5 is a flow chart for another decoder according to a further advantageous embodiment likewise implemented by means of a DSP. The decoder of FIG. 5 is especially adapted to detect a repeating sequence of code symbols (e.g., 5 code symbols) consisting of a marker symbol followed by a plurality (e.g., 4) data symbols wherein each of the code symbols includes a plurality of predetermined frequency components and has a predetermined duration (e.g., 0.5 sec) in the message sequence. It is assumed in this example that each symbol is represented by ten unique frequency components and that the symbol set includes twelve different symbols. It is understood that this embodiment may readily be modified to detect any number of symbols, each represented by one or more frequency components.

Steps employed in the decoding process illustrated in FIG. 5 which correspond to those of FIG. 4 are indicated by the same reference numerals, and these steps consequently are not further described. The FIG. 5 embodiment uses a circular buffer which is twelve symbols wide by 150 FFT periods long. Once the buffer has been filled, new symbol SNRs each replace what are than the oldest symbol SNR values. In effect, the buffer stores a fifteen second window of symbol SNR values. As indicated in step 574, once the circular buffer is filled, its contents are examined in a step 578 to detect the presence of the message pattern. Once full, the buffer remains full continuously, so that the pattern search of step 578 may be carried out after every FFT.

Since each five symbol message repeats every 2½ seconds, each symbol repeats at intervals of 2½ seconds or every 25 FFT's. In order to compensate for the effects of burst errors and the like, the SNR's R₁ through R₁₅₀ are combined by adding corresponding values of the repeating messages to obtain 25 combined SNR values SNRₙ, n=1,2 . . . 25, as follows:

$${SNR}_{n} = {\sum }_{i = 0}^{5} {R}_{n + 25 i}$$

Accordingly, if a burst error should result in the loss of a signal interval i, only one of the six message intervals will have been lost, and the essential characteristics of the combined SNR values are likely to be unaffected by this event.

Once the combined SNR values have been determined, the decoder detects the position of the marker symbol's peak as indicated by the combined SNR values and derives the data symbol sequence based on the marker's position and the peak values of the data symbols. Once the message has thus been formed, as indicated in steps 582 and 583, the message is logged. However, unlike the embodiment of FIG. 4 the buffer is not cleared. Instead, the decoder loads a further set of SNR's in the buffer and continues to search for a message.

As in the decoder of FIG. 4, it will be apparent from the foregoing to modify the decoder of FIG. 5 for different message structures, message timings, signal paths, detection modes, etc., without departing from the scope of the present invention. For example, the buffer of the FIG. 5 embodiment may be replaced by any other suitable storage device; the size of the buffer may be varied; the size of the SNR values windows may be varied; and/or the symbol repetition time may vary. Also, instead of calculating and storing signal SNR's to represent the respective symbol values, a measure of each symbol's value relative to the other possible symbols, for example, a ranking of each possible symbol's magnitude, is instead used in certain advantageous embodiments.

In a further variation which is especially useful in audience measurement applications, a relatively large number of message intervals are separately stored to permit a retrospective analysis of their contents to detect a channel change. In another embodiment, multiple buffers are employed, each accumulating data for a different number of intervals for use in the decoding method of FIG. 5. For example, one buffer could store a single message interval, another two accumulated intervals, a third four intervals and a fourth eight intervals. Separate detections based on the contents of each buffer are then used to detect a channel change.

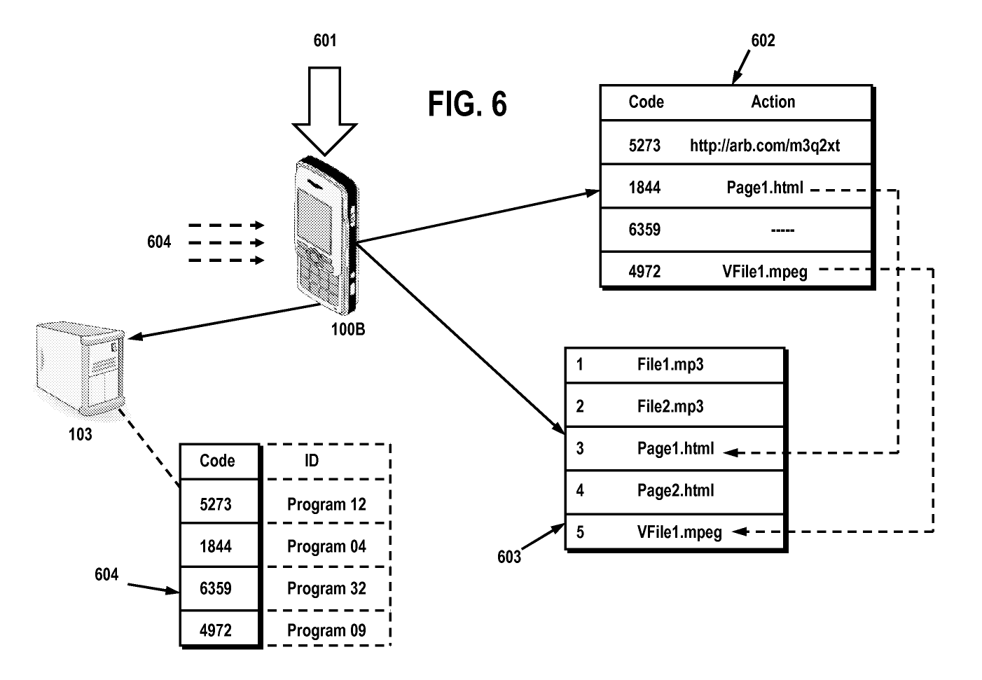

Turning to FIG. 6, an exemplary embodiment is illustrated, where a cell phone 100B receives audio 604 either through a microphone or through a data connection (e.g., WiFi). It is understood that, while the embodiment of FIG. 6 is described in connection with a cell phone, other devices, such as PC's tablet computers and the like, are contemplated as well. Under one embodiment, supplementary research data (601) is “pushed” to phone 100B, and may include information such as a code/action table 602 and supplementary content 603. The content is preferably pushed at predetermined times (e.g., once a day at 8:00 AM) and resides on phone 100B for a limited time period, or until a specific event occurs.

Given that accumulated supplementary data on a device is generally undesirable, it is preferred that pushed content be erased from the device to avoid excessive memory usage. Under one example, content (603) would be pushed to cell phone 100B and would reside in the phone's memory until the next “push” is received. When the content from the second push is stored, the content from the previous push is erased. An erase command (and/or other commands) may be contained in the pushed data, or may be contained in data decoded from audio. Under another embodiment, multiple content pushes may be stored, and the phone may be configured to keep a predetermined amount of pushed content (e.g., seven consecutive days). Under yet another embodiment, cell phone 100B may be enabled with a protection function to allow a user to permanently store selected content that was pushed to the device. Such a configuration is particularly advantageous if a user wishes to keep the content and prevent it from being automatically deleted. Cell phone 100B may even be configures to allow a user to protect content over time increments (e.g., selecting “save today's content”).

Referring to FIG. 6, pushed content 601 comprises code/action table 602, that includes one or more codes (5273, 1844, 6359, 4972) and an associated action. Here, the action may be the execution of a link, display of a HTML page, playing of multimedia, or the like. As audio is decoded using any of the techniques described above, one or more messages are formed on device 100B. Since the messages may be distributed over multiple layers, a received message may include identification data pertaining to the received audio, along with a code, and possibly other data.

Each respective code may be associated with a particular action. In the example of FIG. 6, code “5273” is associated with a linking action, which in this case is a shortened URL (http://arb.com/m3q2xt). The link is used to automatically connect device 100B to a network. Detected code “1844” is associated with HTML page “Pagel.html” which may be retrieved on the device from the pushed content 603 (item 3). Detected code “6359” is not associated with any action, while detected code “4972” is associated with playing video file “VFile1.mpg” which is retrieved from pushed content 603 (item 5). As each code is detected, it is processed using 602 to determine if an action should be taken. In some cases, an action is triggered, but in other cases, no action is taken. In any event, the detected codes are separately transmitted via wireless or wired connection to server 103, which processes code 604 to produce research data that identifies the content received on device 100B.

Utilizing encoding/decoding techniques disclosed herein, more complex arrangements can be made for incorporating supplementary data into the encoded audio. For example, multimedia identification codes can be embedded in one layer, while supplementary data (e.g., URL link) can be embedded in a second layer. Execution/activation instruction codes may be embedded in a third layer, and so on. Multi-layer messages may also be interspersed between or among media identification messages to allow customized delivery of supplementary data according to a specific schedule.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method accessing supplementary data on a device capable of receiving multimedia, comprising:
receiving the multimedia in the device;
decoding ancillary code from an audio portion of the multimedia, said ancillary code comprising a plurality of code symbols arranged in a plurality of layers in a predetermined time period, wherein data associated with the supplementary data is arranged in at least one of the plurality of layers; and
accessing the supplementary data using the data associated with the supplementary data.

2. The method according to claim 1, wherein the supplementary data comprises one of video, audio, images, HyperText Markup Language (HTML) content, a Uniform Resource Locator (URL), a shortened URL, metadata, and text.

3. The method according to claim 1, wherein the supplementary data is accessed on the device.

4. The method according to claim 1, wherein the supplementary data is accessed from a network.

5. The method according to claim 1, further comprising the step of receiving further supplementary data after the supplementary data is accessed.

6. The method according to claim 1, wherein the device comprises one of a cell phone, smart phone, personal digital assistant, personal computer, portable computer, television, set-top box, and media box.

7. An apparatus for accessing supplementary data, comprising:
an interface for receiving the multimedia on the device;
a decoder, coupled to the interface, for decoding ancillary code from an audio portion of the multimedia, said ancillary code comprising a plurality of code symbols arranged concurrently in a plurality of layers in a predetermined time period, wherein data associated with the supplementary data is arranged in at least one of the plurality of layers; and
a processor, coupled to the decoder for accessing the supplementary data using the data associated with the supplementary data.

8. The apparatus according to claim 7, wherein the supplementary data comprises one of video, audio, images, HyperText Markup Language (HTML) content, a Uniform Resource Locator (URL), a shortened URL, metadata, and text.

9. The apparatus according to claim 7, further comprising a storage, wherein the supplementary data is accessed from the storage.

10. The apparatus according to claim 7, wherein the supplementary data is accessed from a network via the interface.

11. The apparatus according to claim 7, wherein further supplementary data is received after the supplementary data is accessed.

12. The apparatus according to claim 7, wherein the apparatus comprises one of a cell phone, smart phone, personal digital assistant, personal computer, portable computer, television, set-top box, and media box.

13. The apparatus according to claim 7, wherein the decoder performs a transformation on the audio portion for decoding the ancillary code.

14. A method accessing supplementary data on a device capable of receiving multimedia, comprising:
performing a transformation on an audio portion of the multimedia received on the device;
detecting ancillary code from the transformed audio portion, said ancillary code comprising a plurality of code symbols arranged in a plurality of layers in a predetermined time period, wherein data associated with the supplementary data is arranged in at least one of the plurality of layers; and
accessing the supplementary data using the data associated with the supplementary data.

15. The method according to claim 14, wherein the supplementary data comprises one of video, audio, images, HyperText Markup Language (HTML) content, a Uniform Resource Locator (URL), a shortened URL, metadata, and text.

16. The method according to claim 14, wherein the supplementary data is accessed on the device.

17. The method according to claim 14, wherein the supplementary data is accessed from a network.

18. The method according to claim 14, further comprising the step of receiving further supplementary data after the supplementary data is accessed.

19. The method according to claim 14, wherein the device comprises one of a cell phone, smart phone, personal digital assistant, personal computer, portable computer, television, set-top box, and media box.
